(19) United States
(12) Patent Application Publication
(10) Pub. No.: US 2025/0196163 A1
(43) Pub. Date: Jun. 19, 2025

(54) DECANTER CENTRIFUGE WITH LAMELLAE FOR IMPROVED FINES RECOVERY

(71) Applicant: FLSmidth A/S, Valby (DK)

(72) Inventor: David Starr, Forest Lake (AU)

(21) Appl. No.: 18/847,664

(22) PCT Filed: Mar. 15, 2023
(86) PCT No.: PCT/IB2023/052536

§ 371 Date: Sep. 16, 2024

Related U.S. Application Data
(60) Provisional application No. 63/320,045, filed on Mar. 15, 2022.

(51) Int. Cl. B04B 3/04; B04B 1/20

(52) U.S. Cl. CPC B04B 3/04; B04B 1/20; B04B 2001/2058

(57) ABSTRACT

A scroll assembly (1) for a centrifuge (100) may be characterised in that it includes at least one lamellae pack assembly (11) proximate the first end (9) of the scroll (2). The lamellae pack assembly (11) may have a plurality of lamella plates (11d) and be positioned upstream of a weir (31) or an effluent exit port (4) that permits a liquid fraction (33) of said infeed slurry to discharge from the centrifuge (100). The lamella plates (11d) are preferably configured and arranged to bias fine solids (35) entrained within the liquid fraction (33) radially-outwardly or at least hinder their radially-inwardly migration as the liquid fraction (33) passes through the lamella plates (11d) and before the liquid fraction passes the weir (31) or effluent exit port (4), in order to produce discharged clarified liquids (36) which are substantially-free of the fine solids (35).

### CROSS-REFERENCE TO RELATED APPLICATIONS

None.

### FIELD OF THE INVENTION

Embodiments of the invention relate to novel assemblies for centrifuges, in particular, for horizontal screenbowl- or solidbowl-type decanter centrifuges. Embodiments may be especially beneficial for improving performance, efficiency, and/or fines recovery when employed in industrial dewatering processes. The novel assemblies include one or more unique lamellae structures provided adjacent liquid ports of egress to inhibit the escape of fines with effluent. These structures may be configured to be modular, for example, provided in the form of replaceable/serviceable lamella pack cartridges, without limitation.

### BACKGROUND OF THE INVENTION

Centrifuges, also known as decanters or screenbowl/solidbowl centrifuges, are industrial apparatus that are designed to receive slurry (e.g., sludge or slimes) containing particles of solid matter and liquid. They are generally configured to provide a solid-liquid separation function by way of centrifugation and their applications may include minerals, coal, chemical, food processing, paper mills, drilling reclamation, and sewage treatment. An aim of centrifuges is to efficiently provide the cleanest ‘cuts’ between solids and liquids-whilst maximizing throughput and minimizing power.

In particular, for minerals processing applications, particles in the solid fraction of the infeed slurry can comprise fine solid materials such as ore (e.g., coal), without limitation. Infeed slurry axially enters a horizontally-arranged central infeed pipe. The central infeed pipe de-livers the infeed slurry to an inner chamber of a concentrically-arranged scroll which surrounds the pipe. The scroll rotates with an outer tubular bowl. A slightly faster or slower RPM than the bowl is typically required to allow the solids to be progressed. Rotation of the bowl induces gravitational G-forces to the infeed slurry, and rotation of the scroll conveys solids axially along inner surfaces of the bowl. The scroll may also be known as a helically-bladed conveyor or screw conveyor and typically comprises one or more screw flights extending outwardly therefrom as depicted in the appended figures. The bowl is slightly larger in diameter than the scroll and often shares a similar tapered profile.

Continuous inflow of feed slurry, in combination with centrifugal forces generated by the rotation of the bowl, serve to bias the slurry away from the inner belly of the scroll, and radially outwardly through scroll openings and towards inner surface regions of the bowl. After the slurry has sufficiently accumulated along the inner surface regions of the bowl, it continues to distribute itself across the entire inner surface of the bowl. Thereafter, the liquid and solid phases of the slurry begin to stratify in a radial direction (with respect to a cen-tral axis of rotation), due to gravitational forces and differences in relative density between the liquid and solid fractions within the slurry.

Lighter liquid components migrate radially inwardly from inner bowl surfaces towards the central axis of rotation (i.e., towards the scroll), whilst heavier/denser solid components continue to migrate radially-outwardly from the central axis of rotation (i.e., away from the scroll), until an equilibrium operating state is achieved. The stratification process biases liquid components to settle radially-inwardly of the denser solid particles, thus, forming a solid-liquid interface between the solid and liquid strata. Operating parameters such as feed rate, RPM, exit port weir position, and slurry composition (e.g., % solids) may be adjusted to optimize or stabilize the radial distance spanning between the solid-liquid interface and the central axis of rotation. The solid-liquid interface may rest within a flank zone of the screw flights.

Centrifuges work by allowing the formed inner liquid strata to migrate axially, towards one or more exit ports provided to an end cap plate adjacent one end of the bowl, whilst simultaneously axially conveying the underlying solids bed towards a solids discharge which is adjacent to an opposite end of the bowl, in counter-current fashion. The helical screw flights provided to the outer periphery of the scroll assist with axially-conveying the denser/heav-ier solids towards the solids discharge.

To this end, fines within the liquid strata that have not sufficiently migrated outwardly can become entrained in the liquid fraction leaving the effluent exit ports. This compromises liquor clarity, increases turbidity of the liquid fraction, and leads to lost solids product (i.e., poorer recovery of fines).

Accordingly, some in industry have opted to use solidbowl centrifuges instead of screenbowl centrifuges for slurries even with low fines content. Others have opted to reduce the area of exit ports, change the shape of exit ports (or re-locate the exit ports radially inwardly) such that it makes it more difficult for fines to escape with the liquid fraction. Still others might consider constraining or blocking off screenbowl exit ports to further reduce occurrences of fines in the liquid effluent stream, while others might employ adjustable liquid weir systems to ‘skim’ the liquid strata at different radial distances from a central axis of rotation. Unfortunately, the aforementioned work-arounds generally lead to further reductions in throughput or overall efficiency of the centrifuge.

Screenbowls and solidbowls operate very similarly. Some common operation between the two types are that: i.) the feed slurry comes through a feed pipe and is discharged through holes in the scroll body; ii.) solids settle to the outer rotating bowl under gravitational forces

and these solids are scraped along by the scrolls; iii.) the shape of screenbowls and solidbowls are similar in that there are typically flat and inclined sections for the solids to pass through to get to the exit of the centrifuge (i.e., to the solids discharge); iv.) water is removed through weirs in the headwall; v.) the solids collected are scraped out of the water and then discharged to the outlet (i.e., solids discharge) of the centrifuge; vi.) there typically needs to be some small RPM difference between the scroll and bowl in order to allow the relative solids movement along the bowl; vii.) the scroll speed is generally between 20 RPM and 50 RPM different than the bowl; and viii.) slower rotational speed differences can reduce wear and torque.

Screenbowls and solidbowls may include the following distinctions: i.) screenbowls may have a screen section which allows some more drainage through the bed of solids (being pushed along by the scrapers), ii.) screenbowl feeds are generally coarser than traditional solidbowl feeds, iii.) solidbowls generally demonstrate much higher g-forces during their operation than screenbowls; and iv.) solidbowls generally demonstrate a much finer solids range, and may require the use of a flocculant.

Although centrifuges of the prior art have demonstrated limited successes within the solid-liquid separation industry, it is desired to provide a much-improved scroll assembly which enables more efficient solid-liquid separations, mitigates fines entrainment in the liquid effluent, and increases the recovery of fines by capturing them within the solids discharge outflow.

### OBJECTS OF THE INVENTION

According to some embodiments, it is desired to provide a horizontal centrifuge configured to perform solid-liquid separation processes more efficiently, without limitation.

According to some embodiments, it desired to provide an improved scroll assembly for a horizontal centrifuge which performs better than its conventional counterparts, without limitation.

According to some embodiments, it is desired to provide an improved exit port design for a horizontal centrifuge which provides cleaner cuts between solids and liquids, discourages fines entrainment in liquid effluents, and provides better recovery of fines without substantially increasing power consumption or decreasing throughput, without limitation.

According to some embodiments, it is desired to provide an improved exit port design for a horizontal centrifuge which is capable of prevent fines less than 45 microns from escaping with liquid effluents (e.g., configured to restrict passage of fines as small as 20-25 microns or lower size range, without impacting throughput or centrifuge performance), without limi-tation.

According to some embodiments, it is desired to provide novel lamellae structures adjacent one or more exit ports to introduce one or more tortuous paths of resistance to fines and discourage them from escaping with the flow of liquids, without limitation.

According to some embodiments, it is desired to provide means for removing, replacing, and/or servicing the novel lamellae structures, without limitation.

According to some embodiments, it is desired to provide novel lamellae structures which are configured to work with both screenbowl and/or solidbowl centrifuges, without limitation.

These and other objects of the present invention will be apparent from the drawings and description herein. Although every object of the invention is believed to be attained by at least one embodiment of the invention, there is not necessarily any one single embodiment of the invention that achieves all of the objects of the invention.

### BRIEF SUMMARY OF THE INVENTION

A scroll assembly (1) for a centrifuge (100) is disclosed. The scroll assembly (1) may comprise a scroll (2) configured to be positioned within a bowl (30). The scroll assembly (1) may have a first end (9) proximate an effluent discharge and a second end (8) proximate a solids discharge. The scroll (2) may have an inner chamber (39). The inner chamber (39) may be configured to receive infeed slurry from a pipe (5) having an infeed opening (10). The inner chamber (39) may be defined by a tubular scroll wall (4). The tubular scroll wall (4) may comprise a number of slurry openings (14) therethrough. At least one screw flight (6, 7, 15) may be provided to an outer portion of the scroll (2) (e.g., to the tubular scroll wall (4), without limitation). The scroll (2) may be characterised in that it comprises at least one lamellae pack assembly (11). The at least one lamellae pack assembly (11) may be positioned to be proximate the first end (9) of the scroll (2). The lamellae pack assembly (11) may comprise a plurality of lamella plates (11d). The lamellae pack assembly (11) may be positioned upstream of a weir (31) or an effluent exit port (4) that permits a liquid fraction (33) of said infeed slurry to discharge from the centrifuge (100).

The plurality of lamella plates (11d) may be configured and/or arranged to bias fine solids (35) entrained within the liquid fraction (33) radially-outwardly or at least hinder their radi-ally-inwardly migration as the liquid fraction (33) passes between the lamella plates (11d) and before the liquid fraction passes the weir (31) or effluent exit port (4). This may be done in order to produce discharged clarified liquids (36) which are substantially-free of the fine solids (35), without limitation.

According to some embodiments, the at least one lamellae pack assembly (11) may be received within an outer cutout (29), effluent discharge port (4), or lamellae pack receiving portion (29) provided to a portion of a backing plate (27).

According to some embodiments, the at least one lamellae pack assembly (11) may comprise a mounting flange (11b). The mounting flange (11b) may be configured to be fastened to a backing plate (27) or end cap plate (3).

According to some embodiments, the at least one lamellae pack assembly (11) may comprise an end face (11e). The lamella plates (11d) may be captured between the end face (11e) and the mounting flange (11a), without limitation.

According to some embodiments, the end face (11e) and mounting flange (11a) may be provided with slits or slots (11h). The slits or slots (11h) may be configured to receive and/or support tab portions (11i) of the lamella plates (11d) and/or facilitate manufacturing of the lamellae pack assembly (11), without limitation.

According to some embodiments, an end face (11e) of the at least one lamellae pack assembly (11) may abut a weir plate (23). The weir plate (23) may comprises the weir (31) or a backing plate (27).

According to some embodiments, the weir plate (23) may abut an end cap plate (3) comprising the effluent exit port (4).

According to some embodiments, a flow entry side (11f) of the at least one lamellae pack assembly (11) may be positioned radially-inwardly of a solid-liquid interface (36) while the centrifuge (100) is in operation, in relation to a central axis of rotation (21). The flow entry side (11f) of the at least one lamellae pack assembly (11) may be positioned radially-outwardly of a discharge entry side (11g) of the at least one lamellae pack assembly (11).

According to some embodiments, the scroll assembly may comprise a plurality of lamellae pack assemblies (11), wherein an annular shroud (26) may separate and/or span between a flow entry side (11f) of each of said plurality of lamellae pack assemblies (11). The annular shroud (26) may be configured to bias the liquid fraction (33) towards said flow entry side (11f) of each of said plurality of lamellae pack assemblies (11).

According to some embodiments, the at least one lamellae pack assembly (11) may be removable and/or replaceable for cleaning or servicing.

According to some embodiments, the at least one lamellae pack assembly (11) may be removable and/or replaceable for cleaning or servicing from only a first end (9) of the scroll assembly (1).

According to some embodiments, the scroll assembly may further comprise and/or be situated within a bowl (30). The bowl (30) may be selected from a screenbowl or a solidbowl.

### DESCRIPTION OF THE DRAWINGS

To complement the description which is being made, and for the purpose of aiding to better understand the features of the invention, a set of drawings illustrating preferred, non-limiting embodiments of an improved scroll assembly 1 and components thereof for use in a centrifuge is attached to the present specification as an integral part thereof, in which the following has been depicted with an illustrative and non-limiting character. It should be understood that like reference numbers used in the drawings.

FIG. 1 shows a side isometric view of an exemplary scroll assembly 1 comprising a scroll 2 and lamellae pack assemblies 11, according to embodiments.

FIG. 2 shows a partial cutaway view of the scroll assembly 1 in FIG. 1.

FIG. 3 shows a close-up view of an effluent discharge end of the scroll assembly 1 shown in FIG. 1, depicting the end cap plate 3 removed from the effluent discharge end 9 for clarity.

FIG. 4 is an alternate view of FIG. 3, depicting the weir plate 23 removed from the effluent discharge end 9 for clarity.

FIG. 5 is a close-up view of a portion of FIG. 4.

FIG. 6 is an alternate view of FIG. 5, depicting side baffles 25 removed for clarity.

FIGS. 6-14 show how one or more lamellae pack assemblies 11 may be provided to a scroll assembly 1 in a “rear-mounting” configuration.

FIG. 7 is an alternate view of FIG. 6 showing backing plate 27 removed for clarity and better understanding.

FIG. 8 is a front cutaway view of the upper left component (i.e., lamellae pack assembly 11) in FIG. 7.

FIG. 9 shows a side cutaway view of the lamellae pack assembly 11 of FIG. 7, the cutaway plane being orthogonal to the cutaway plane of FIG. 7.

FIG. 10 shows an alternative isometric view of the lamellae pack assembly 11 depicted in the upper left of FIG. 7.

FIG. 11 depicts an alternative cutaway view of the scroll assembly 1 shown in FIG. 1.

FIG. 12 is a closeup view of the indicated portion of FIG. 11.

FIG. 13 is a closeup view of the indicated portion of FIG. 12.

FIG. 14 depicts another view of the indicated portion of FIG. 12.

FIG. 15 depicts a photograph of a centrifuge comprising the scroll assembly 1 depicted in FIGS. 1-14.

FIGS. 16-18 show how one or more lamellae pack assemblies 11 may be provided to a scroll in a “front-mounting” configuration.

FIG. 16 depicts an alternative embodiment of a lamellae pack assembly 11 which can be inserted and removed from a first (discharge) end 9 of a scroll assembly 1.

FIG. 17 depicts a cutaway view of a scroll assembly 1 with the lamellae pack assembly 11 of FIG. 16 installed therein.

FIG. 18 depicts a partial isometric end view of a scroll assembly 1 with the lamellae pack assembly 11 of FIG. 16 installed therein, with arrows depicting a direction of removal of the lamellae pack assemblies 11.

FIG. 19 depicts a screenbowl which may contain the scroll assembly 1 depicted in FIG. 18—and which may be used in the centrifuge (100) depicted in FIG. 15.

FIG. 20 depicts a solidbowl which may contain the scroll assembly 1 depicted in FIG. 18—and which may be used in the centrifuge (100) depicted in FIG. 15.

In the following, the invention will be described in more detail with reference to drawings in conjunction with exemplary embodiments.

### DETAILED DESCRIPTION

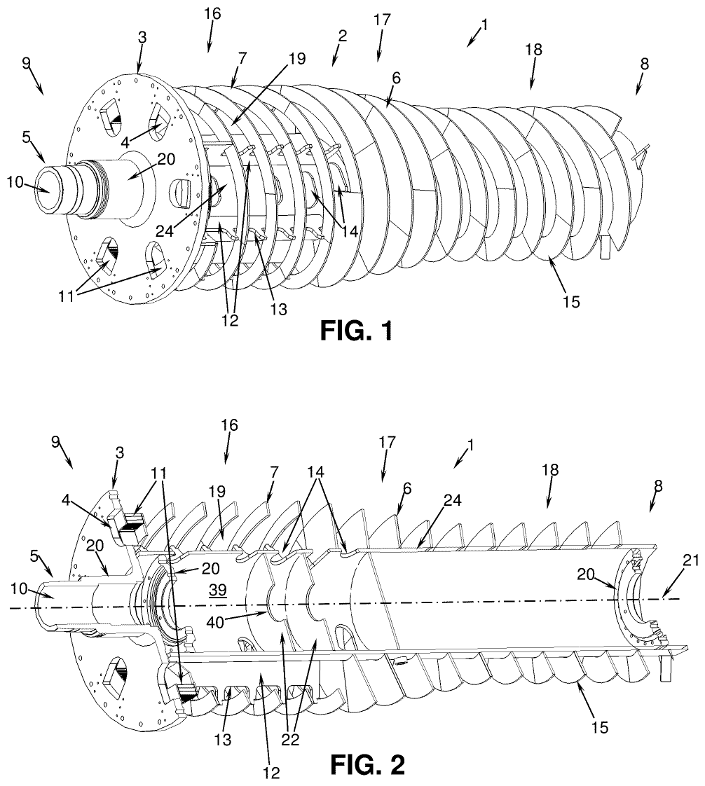

A novel scroll assembly 1 for a centrifuge 100 is disclosed. As depicted in FIGS. 1 and 2, the scroll assembly 1 comprises a scroll structure 2 and has a first end 9 for providing egress of liquid effluent fractions of infeed slurry, and a second end 8 opposite the first end 9 for providing egress of solid fractions of infeed slurry. The scroll assembly 1 may rotates about a central axis of rotation 21 extending between the first 9 and second 8 ends. The scroll assembly 1 is designed to be installed in a centrifuge 100, such as the one depicted in FIG. 15.

Infeed slurry enters a slurry infeed opening 10 and is transferred, via a pipe 5 to an inner chamber 39. The inner chamber 39 may be provided with one or more inner baffles therein 22 for stabilizing the slurry within the inner chamber 39. Where employed, the inner baffles 22 may comprise slurry openings 40, such as a central aperture or orifice, as shown. By virtue of centrifugation, slurry in the inner chamber 39 may exit the inner chamber 39 radially-outwardly through one or more slurry openings 14. Centrifugated slurry 32 moves radially outwardly towards an outer bowl 30 surrounding the screw 2.

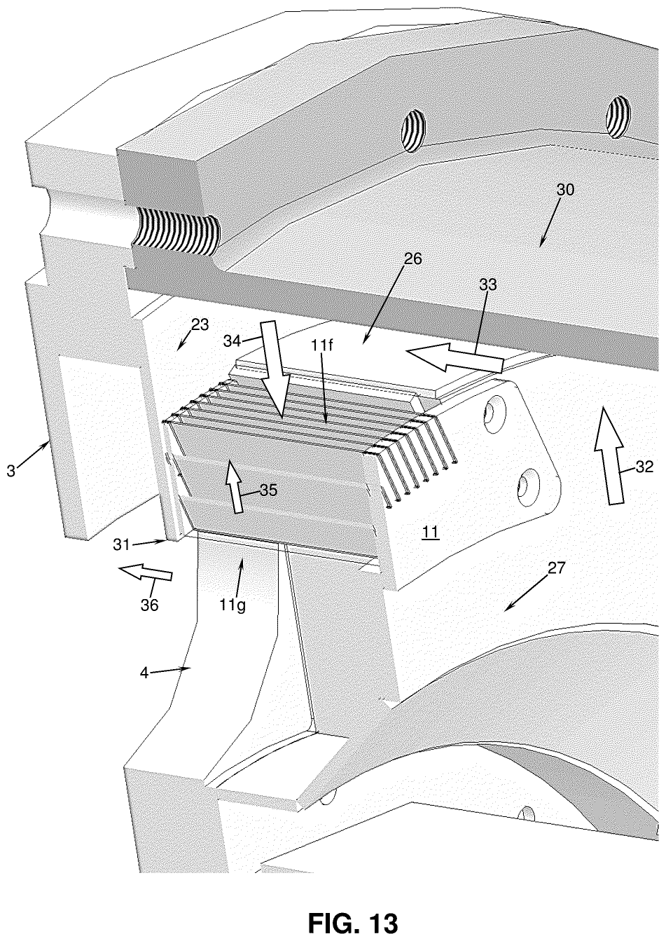

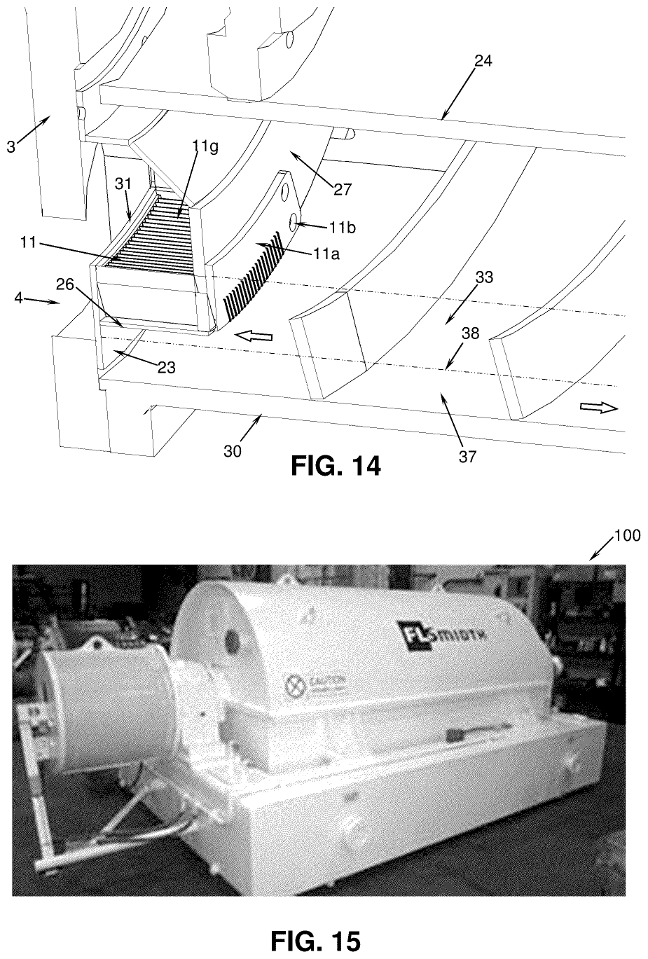

As suggested in FIGS. 13 and 14, the centrifugated slurry 32 begins to stratify into a solid fraction strata 37 (closer to the bowl 30), and a liquid fraction strata 33 (further from the bowl 30). A solid-liquid interface 38 may be loosely defined between the solid fraction strata 37 and liquid fraction strata 33, although this interface may not be a sharp cutoff and may be defined as an intermediate strata or layer therebetween.

The scroll assembly 1 may comprise an end cap plate 3 adjacent the first end 9. The end cap plate 3 may comprise one or more (preferably a plurality of) effluent exit ports 4. These effluent exit ports 4 enable clarified liquid fractions of the infeed slurry to be discharged from the centrifuge 100 by virtue of making its way out from a chamber defined between the scroll 2 and the bowl 30.

An outer (tapered) screw/ribbon flight 6 may be provided to and/or surround a scroll wall 24. The scroll wall 24 may, as shown, define a boundary of the inner chamber 39, and may comprise the one or more slurry openings 14. The screw/ribbon flight 6 may comprise a, for example, at a middle 17 section of the scroll assembly 1. The tapered screw/ribbon flight 6 may continuously make its way around the scroll wall 24 from adjacent the first end 9 to the second end 8 traversing a first section 16, a middle section 17, and a second section 18. As depicted, a portion of the screw/ribbon flight 6 may be tapered in the middle section 17, for example, such that its outer diameter narrows towards the second end 8 and/or second section 18, without limitation. Moreover, as shown, a portion of the screw/ribbon flight 6 may comprise a floating screw/ribbon flight 7 in the first section 16 or adjacent the first end 9, without limitation.

If employed, the floating screw/ribbon flight 7 may be supported by one or more standoffs 12, such as one or more vanes which extend radially-outwardly from the scroll wall 24. The standoffs 12 may be configured to extend along the scroll wall 24 in a direction parallel to the central axis of rotation 21 as shown. The one or more standoffs 12 may comprise one or more raised seats 13 for supporting a radially inner surface or contact point of the floating screw/ribbon flight 7. The one or more raised seats 13 may be configured as “cutouts” in a generally planar standoff 12 as depicted. Alternatively, while not shown, standoffs 12 may simply be constructed from isolated upstanding support elements or flanges extending from the scroll wall 24 at unique independent locations along the scroll wall 24, without limitation.

By virtue of the design and configuration of the floating screw/ribbon flight 7, standoffs 12, and raised seats 13 supporting the floating screw/ribbon flight 7, a number of open axial effluent pathways 19 are formed between the scroll wall 24 and the floating screw/ribbon flight 7 in the first section 16 adjacent the first end 9. These open axial effluent pathways 19 may provide for less turbulent flows of counter-current strata 33, 37 as material traverses axially between the bowl 30 and scroll 2. In particular, the open axial effluent pathways 19 defined by the floating screw/ribbon flight 7 may serve to allow a liquids frac-tion 33 of the centrifuged slurry 32 to more easily migrate axially towards the first end 9 and through effluent exit ports 4 without turbulence or mechanical structure-induced disturbances (which could lead to further fine solids entrainment in the discharged clarified liquids 36 and/or higher turbidity of the discharged clarified liquids 36).

As most clearly seen from FIG. 1, the floating screw/ribbon flight 7 portion of the screw/ribbon flight 6 may transition to meet the scroll wall 24 in a central region of the scroll 2 (e.g., in the middle section 17, without limitation. A portion of the screw/ribbon flight 6 towards the second end 8 of the scroll assembly 1 may comprise a discharge screw/ribbon flight 15, which may or may not be tapered.

It should be understood that while a single screw/ribbon flight 6 is depicted, multiple screw/ribbon flights 6 may be provided and nested or interspersed within one another to form a multiple-helix scroll 2, without limitation.

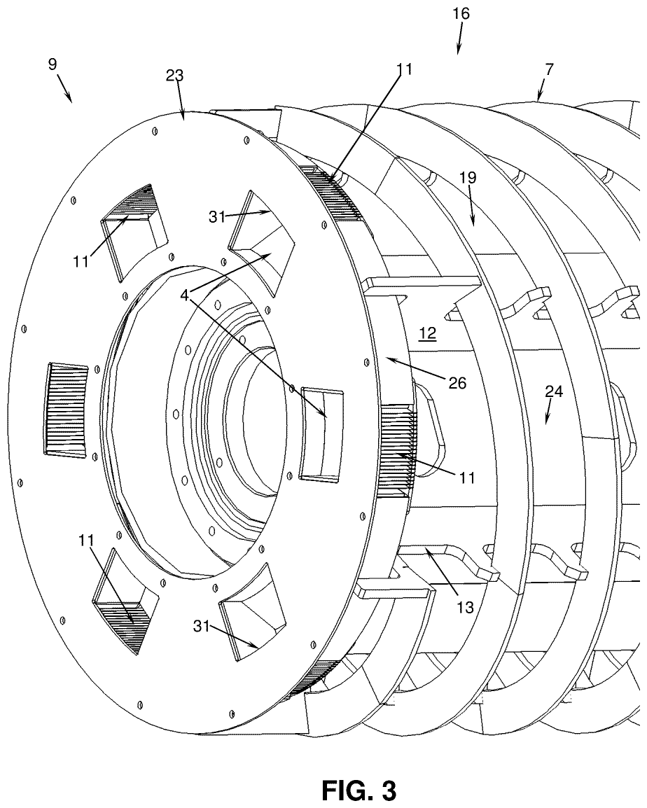

FIG. 3 shows the first end 9 of the scroll assembly 1 without the end cap plate 3. As shown, a weir plate 23 may be provided underneath the end cap plate 3. The weir plate 23 may comprise a number of circumferentially-spaced openings theretherough, each defining a portion of effluent exit ports 4 and being aligned with openings through the end cap plate 3. The openings extending through the weir plate 23 may have a radially-outer edge that defines a weir 31. Behind the weir plate 23 may be an annular shroud extending generally perpendicularly and/or axially from the weir plate 23. A lamellae pack assembly 11 (e.g., a lamella “cartridge”) may be provided behind the weir plate 23 adjacent one, some, or each of the effluent exit ports 4, without limitation.

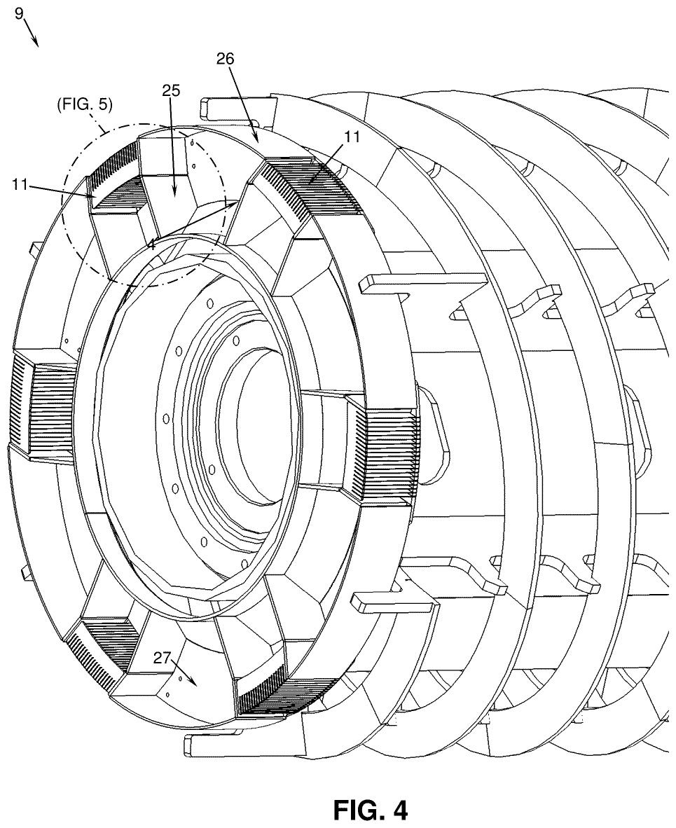

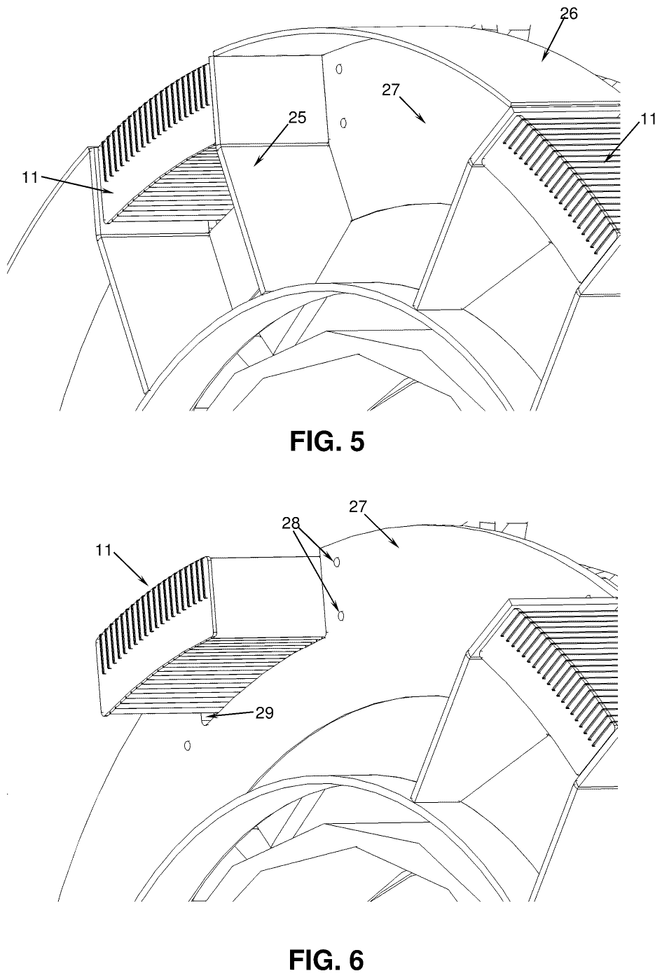

Turning now to FIGS. 4 and 5, with weir plate 23 shown to be removed for clarity, it can be seen that a plurality of lamellae pack assemblies 11 may be situated between side baffles 25 behind the weir plate 23. For example, the side baffles 25 may extend radially-inwardly from the annular shroud 26 and form an integral portion thereof. A backing plate 27 may be provided behind the side baffles and may extend radially-inwardly from the shroud 26. The backing plate 27 may form an integral part of the annular shroud 26, without limitation.

FIG. 6 depicts the assembly seen in FIGS. 4 and 5, with the shroud 26 and side baffles 25 re-moved for clarity and better understanding. Here, it can be seen that the lamellae pack as-semblies may be mounted to the backing plate 27 in a “rear-mounting” configuration. One

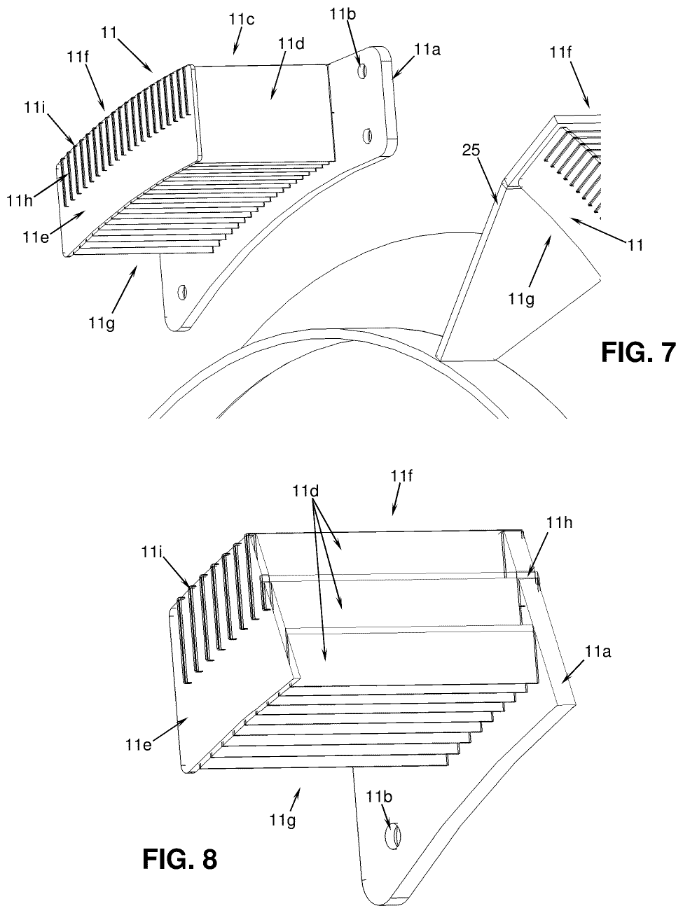

or more securement features 28 may be provided to the backing plate 27. These securement features 28 may be configured to be complementary with and/or align with one or more securement features provided to the lamellae pack assemblies 11. Non-limiting examples of securement features 28 may include, without limitation, one or more locking tabs, one or more fasteners, adhesive or welds between the backing plate 27 and lamellae pack assemblies, or one or more mechanical mounting mechanisms for attaching the lamellae pack assemblies 11 to the backing plate 27. Any means for mounting known in the art may be employed; however, as depicted, such means may comprise securement features provided as simple holes in the backing plate 27 for engagement with fasteners, wherein the holes in the backing plate 27 align with respective mounting holes 11b provided to portions of the lamellae pack assemblies 11. This may be made clearer from FIG. 7, which depicts a lamellae pack assembly 11 comprising mounting holes 11b provided to a mounting flange 11a, the mounting flange 11a being configured to rest against a back side of the backing plate 27 and the mounting holes 11b being configured to align with the one or more securement features 28 provided to the backing plate 27.

As can be inferred from FIG. 6, the one or more lamellae pack assemblies 11 may be situated in respective outer cutout/lamellae pack receiving portions 29 of the backing plate 27. These outer cutout/lamellae pack receiving portions 29 may be positioned along a periphery of the backing plate 27 and circumferentially-aligned with effluent exit ports 4 for providing a clearance for the lamellae pack assemblies 11 to be seated.

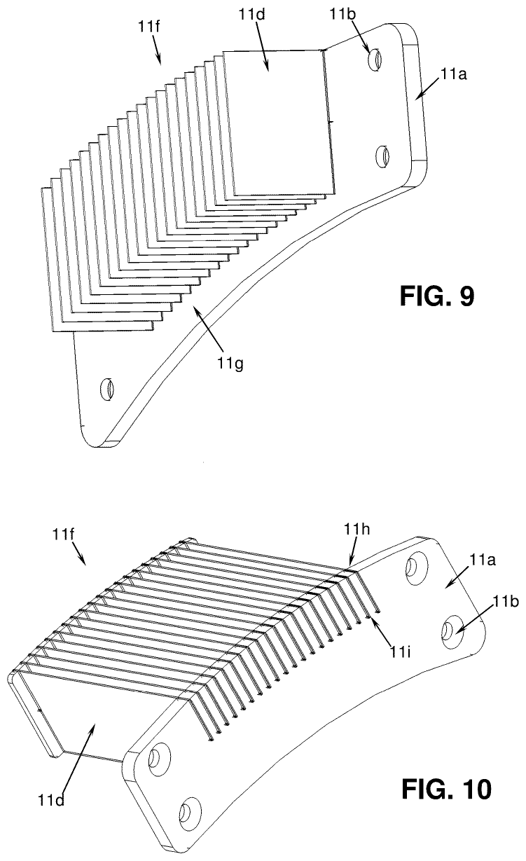

Turning now to FIGS. 7-10, a lamellae pack assembly/cartridge 11 may comprise a body 11c defined by a plurality of closely-spaced lamella plates 11d extending between a mounting flange 11a and an end face 11e. The lamella plates 11d preferably extend generally perpendicularly between the mounting flange 11a and end face 11e, and are preferably parallel to one another. Moreover, the lamella plates 11d are configured to extend obliquely, relative to a radial from the central axis of rotation 21, such that the lamellae surfaces provide a positive or negative angle of attack for flows in a purely radial direction with respect to the central axis of rotation 21. Each lamellae pack assembly/cartridge 11 may comprise a flow entry side 11f for receiving a flow between the lamella plates 11d, and a flow discharge side 11g for discharging a flow from between the lamella plates 11d. The flow entry side 11f is located radially-outward of the flow discharge side 11g when installed, in relation to the scroll assembly 1 and with respect to its central axis of rotation 21.

To improve fabrication, reduce manufacturing costs, or facilitate construction of the lamellae pack assemblies 11, lamella plates 11d may be configured with lamella tab portions 11i that align with and are complimentarily received by respective slits or slots 11h in the mounting flange 11a and end face 11e of each assembly 11. A welding or adhesion process may follow to permanently secure the lamella plates 11d to the mounting flange 11a and end face 11e. It should be understood that interference fits may be provided between the slits/slots 11h and lamella tab portions 11i, and that other alternative means for fabrication may be utilized.

The scroll assembly 1 is situated within a bowl 30 and rotates about its central axis of rotation 21 by virtue of being supported by one or more bushings, bearings, or journals 20. The bowl 30 and scroll assembly 1 may be independent from one another and may rotate at slightly different rotational speeds.

Turning now to FIGS. 13 and 14, as the scroll assembly 1 and bowl 30 are rotated, centrifugated slurry 32 from the inner chamber 39 gets flung radially-outwardly against bowl 30. A stratified layer of solids 37 remains adjacent an inner surface of the bowl 30, and a stratified layer of liquids 33 migrates radially-inwardly due to gravitational forces and a differences in specific gravity/density between the solid and liquid fractions of the centrifugated slurry 32.

The liquids fraction 33 migrates axially towards the shroud 26 and eventually finds openings therethrough. Radially-inwardly-migrating liquid fraction 34 proceeds to enter through the flow entry sides 11f of the lamellae pack assemblies 11 and proceed radially-inwardly and over the weirs 31 into the effluent exit ports 4 before being discharged from the centrifuge 100. The radially-inwardly-migrating liquid fraction 34 typically will contain some entrained fine solids, and these entrained fine solids increase turbidity of the discharged clarified liquids 36.

However, by virtue of the inclined channels formed between the lamella plates 11d, the unwanted fines are inhibited from further radial-inward migration through the lamellae pack assemblies 11. Thus, radially-outwardly-migrating fine solids 35 (between Lamella plates 11d) which were previously entrained in the radially-inwardly-migrating liquid fraction 34 are biased away from the flow discharge sides 11g of the lamellae pack assemblies 11 and are forced to migrate back through the flow entry sides 11f of the lamellae pack assemblies 11 from which they came. These “rejected fines” eventually re-combine with the solids strata 37 along the bowl 30 and progress towards the solids discharge end 8 of the centrifuge 100.

In short, by providing one or more lamellae pack assemblies 11 near a liquid discharge end 9 of a scroll assembly 1, turbidity of the discharged clarified liquids 36 may be reduced. Moreover, when combined with the open axial effluent pathways 19 defined by the floating screw/ribbon flight 7, less turbulence occurs between the scroll 2 and bowl 3 synergistically contributing to less fine solids entrainment, lower turbidity of liquid effluent products, and higher solids recovery of a centrifuge 100.

In some embodiments, the lamella plates 11d of the lamellae plate assembly 11 may comprise inclined plates having 60 to 80 degrees of incline with respect to a radial extending perpendic-ularly from a central axis of rotation 21 of the scroll assembly 1, for example, approximately

70 degrees (+5 degrees), without limitation.

In some embodiments, the lamella plates 11d may have a plate gap (i.e., spacing between lamella plates 11d) of between approximately 1 to 30 mm, for example, a plate gap of approximately 2 to 6 mm, without limitation. The lamella plates 11d are preferably parallel to each other with little skew.

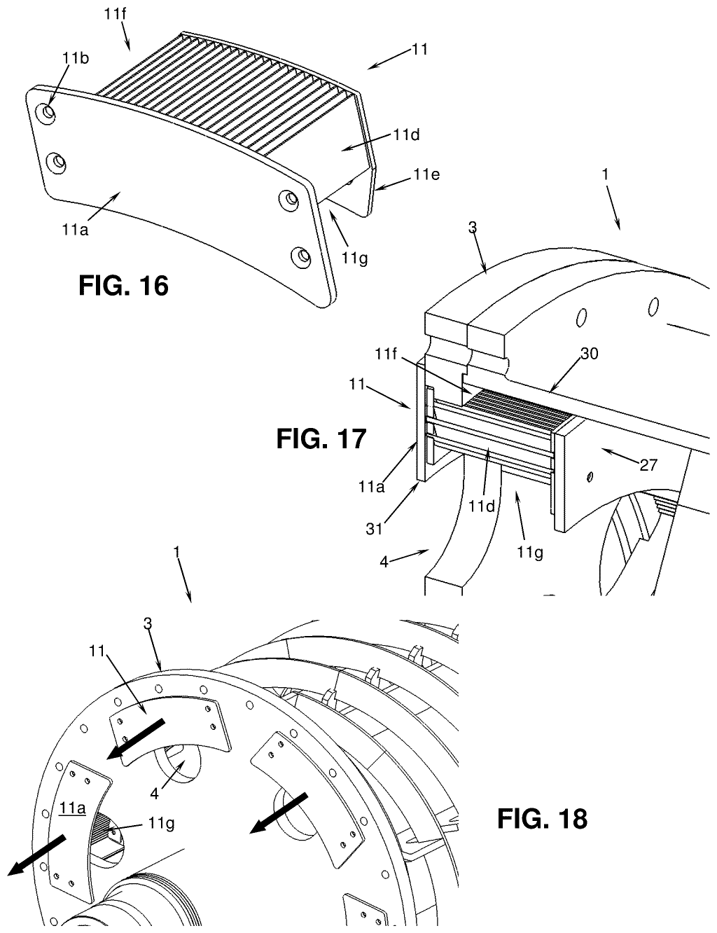

A water fraction/liquid component 33 of slurry is pulled into the lamella plate assembly 11 from flow entry side 11f to flow discharge side 11g. As the water fraction/liquid component 33 passes through the plate gaps between the lamella plates 11d, a solid-liquid separation occurs by virtue of the angled lamella plates impeding the radially-inward movement of fine particles. Fines that are entrained in the water fraction/liquid component 33 of slurry move radially inwardly, but contact surfaces of the lamella plates 11d in the channels formed therebetween (by plate gaps), and find resistance and slide back radially outwardly towards bowl 30 due to centrifugal forces. Clarified water/liquid is discharged through the flow discharge end 11g at the radially inward section of the plates, and passes through a weir section. In the embodiment depicted in FIGS. 16-20, the weir section may comprise a weir 31 which is formed by a portion (e.g., edge or rim) of mounting plate 11a, without limitation.

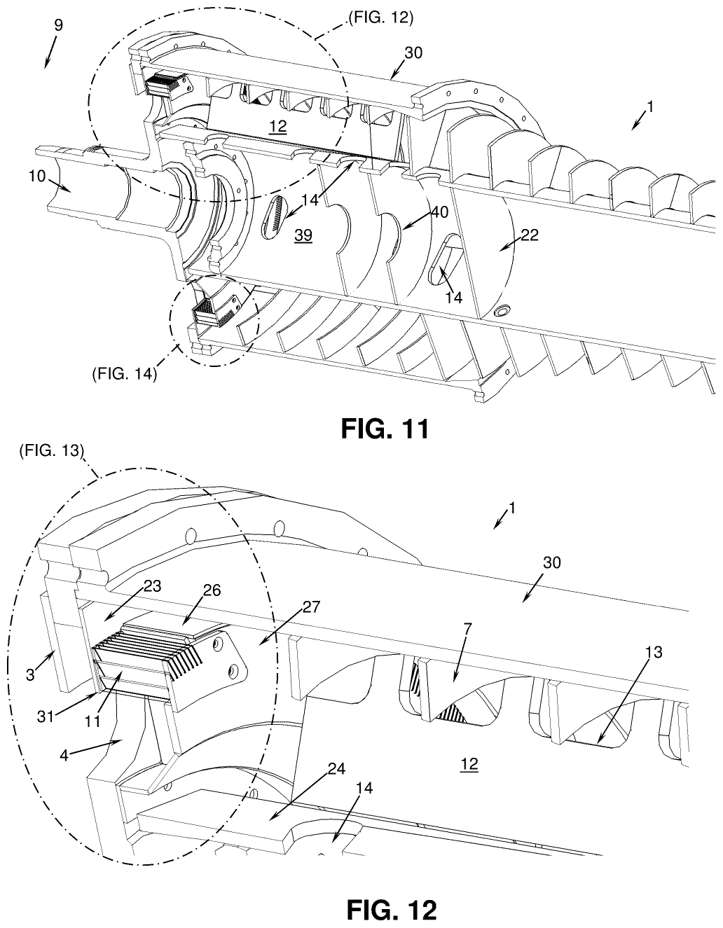

In the embodiment depicted in FIGS. 6-14, the weir section may comprise a weir 31 which is formed by a portion (e.g., edge or rim) of back plate 11e, and/or weir plate 23, without limi-tation.

Small diameter solid particles pulled into the lamellae pack assembly 11 and between the lamella plates 11d are subject to the velocity of the water flow in the channels therebetween. The radially-inward component of the velocity of the water flow in the channels “lifts” the particles away from bowl 30 and towards the flow discharge side 11g of the lamella plate assembly 11. However, the very large centrifugal g forces acting radially-outwardly on the particles causes the small diameter particles to hit an inclined surface of the lamella plates 11d and cause it to slide out the lamella channel entry point. Thus, many small diameter solid particles exit back through the flow entry side 11f from which they entered, and preferably re-consolidate with the solid strata 37 formed adjacent the bowl 30.

Previously, with prior art designs, non-floating screw flight designs within the first section 16 created some turbulence when liquids were trying to get to the weir 31 for discharge from the centrifuge 100. This turbulence could have the potential to pull large quantities of particles (e.g., approximately −0.045 mm particles) out of the solids bed 37 and be discharged through the weir 31 with the discharged clarified liquids 36.

The unique floating screw flight 7 design, and its location (i.e., near the first end 9 of the scroll) reduces local turbulence of flows and allows any fine solids discharging from the lamella to settle easily on the solids bed formed near surfaces of bowl 30. Also, the floating ribbon flight 7 design easily allows a smaller blade section to be run under the lamella entrance section 11f to prevent build up from the discharge of fines.

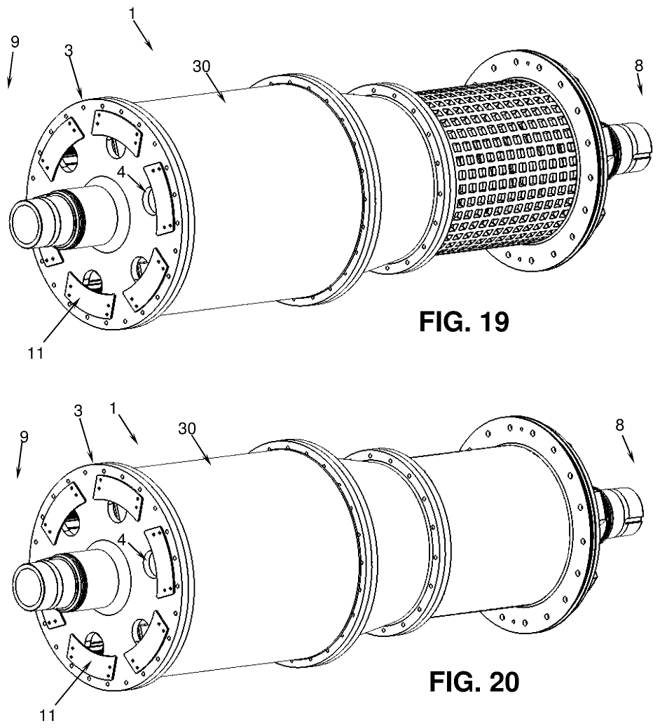

As suggested from FIGS. 19 and 20, it should be understood that features of the disclosed embodiments may be practiced with screenbowls (FIG. 19), as well as with solidbowls (FIG. 20), without limitation.

It should be known that the specific features, functions, process steps, and possible benefits shown and described herein in detail are purely exemplary in nature and should not limit the spirit and/or scope of the invention.

Moreover, although the invention has been described in terms of particular embodiments and applications, one of ordinary skill in the art, in light of these teachings, can generate additional embodiments and modifications without departing from the spirit of the claimed invention.

Accordingly, it is to be understood that the drawings and descriptions herein are proffered by way of example to facilitate comprehension of the invention and should not be construed to limit the scope thereof.

### LISTING OF REFERENCE NUMERALS

1 Scroll assembly
2 Scroll
3 End cap plate
4 Effluent exit ports
5 Pipe
6 Screw/ribbon flight (tapered)
7 Floating screw/ribbon flight
8 Second end (solids discharge end)
9 First end (effluent discharge end)
10 Slurry infeed opening
11 Lamellae pack assembly/cartridge
11a Mounting flange
11b Mounting hole
11c Body
11d Lamella plate
11e End face
11f Flow entry side
11g Flow discharge side
11h Slit/slot
11i Lamella tab portions
12 Standoff(s)
13 Raised seat
14 Slurry openings
15 Screw/ribbon flight (discharge)
16 First section
17 Middle section
18 Second section
19 Open axial effluent pathways
20 Bushing/bearing/journal
21 Central axis of rotation
22 Inner baffle
23 Weir plate
24 Scroll wall
25 Side baffles
26 Shroud
27 Backing plate
28 Securement features (e.g., locking tabs, fasteners, adhesive, or mounting mechanism)
29 Outer cutout/lamellae pack receiving portion
30 Bowl
31 Weir
32 Centrifuged slurry
33 Liquid fraction strata (furthest from Bowl 30)
34 Radially-inwardly-migrating liquid fraction
35 Radially-outwardly-migrating entrained fine solids (between Lamella plates 11d)
36 Discharged clarified liquids
37 Solid fraction strata (close to Bowl 30)
38 Solid-liquid interface
39 Inner chamber
40 Slurry opening
100 Centrifuge

1. A scroll assembly (1) for a centrifuge (100), the scroll assembly (1) comprising:
a scroll (2) configured to be positioned within a bowl (30) and having a first end (9) proximate an effluent discharge and a second end (8) proximate a solids discharge; the scroll (2) having an inner chamber (39) configured to receive infeed slurry from a pipe (5) having an infeed opening (10); the inner chamber (39) being defined by a tubular scroll wall (4) having a number of slurry openings (14) therethrough; wherein at least one screw flight (6, 7, 15) is provided to an outer portion of the scroll (2); the scroll (2) being CHARACTERIZED IN THAT it further comprises:
at least one lamellae pack assembly (11) proximate the first end (9) of the scroll (2); the lamellae pack assembly (11) comprising a plurality of lamella plates (11d); the lamellae pack assembly (11) being positioned upstream of a weir (31) or an effluent exit port (4) that permits a liquid fraction (33) of said infeed slurry to discharge from the centrifuge (100);
wherein the plurality of lamella plates (11d) are configured and arranged to bias fine solids (35) entrained within the liquid fraction (33) radially-outwardly or at least hinder their radially-inwardly migration as the liquid fraction (33) passes between the lamella plates (11d) and before the liquid fraction passes the weir (31) or effluent exit port (4), in order to produce discharged clarified liquids (36) which are substantially-free of the fine solids (35).

2. The scroll assembly (1) for a centrifuge (100) according to claim 1, wherein the at least one lamellae pack assembly (11) is received within an outer cutout (29), effluent dis-charge port (4), or lamellae pack receiving portion (29) provided to a portion of a backing plate (27).

3. The scroll assembly (1) for a centrifuge (100) according to any one of the preceding claims, wherein the at least one lamellae pack assembly (11) comprises a mounting flange (11b) which is configured to be fastened to a backing plate (27) or end cap plate (3).

4. The scroll assembly (1) for a centrifuge (100) according to any one of the preceding claims, wherein the at least one lamellae pack assembly (11) comprises an end face (11e), wherein the lamella plates (11d) are captured between the end face (11e) and the mount-ing flange (11a).

5. The scroll assembly (1) for a centrifuge (100) according to claim 4, wherein the end face (11e) and mounting flange (11a) are provided with slits or slots (11h), which are configured to receive and/or support tab portions (11i) of the lamella plates (11d) and facilitate manufacturing of the lamellae pack assembly (11).

6. The scroll assembly (1) for a centrifuge (100) according to any one of the preceding claims, wherein an end face (11e) of the at least one lamellae pack assembly (11) abuts a weir plate (23) that comprises said weir (31) or a backing plate (27).

7. The scroll assembly (1) for a centrifuge (100) according to claim 6, wherein the weir plate (23) abuts an end cap plate (3) comprising the effluent exit port (4).

8. The scroll assembly (1) for a centrifuge (100) according to any one of the preceding claims, wherein a flow entry side (11f) of the at least one lamellae pack assembly (11) is positioned radially-inwardly of a solid-liquid interface (36) while the centrifuge (100) is in operation, in relation to a central axis of rotation (21) and further positioned radially-outwardly of a discharge entry side (11g) of the at least one lamellae pack assembly (11).

9. The scroll assembly (1) for a centrifuge (100) according to any one of the preceding claims, comprising a plurality of lamellae pack assemblies (11), wherein an annular shroud (26) separates and/or spans between a flow entry side (11f) of each of said plurality of lamellae pack assemblies (11), the annular shroud (26) being configured to bias the liquid fraction (33) towards said flow entry side (11f) of each of said plurality of lamellae pack assemblies (11).

10. The scroll assembly (1) for a centrifuge (100) according to any one of the preceding claims, wherein the at least one lamellae pack assembly (11) is removable and/or replacea-ble for cleaning or servicing.

11. The scroll assembly (1) for a centrifuge (100) according to claim 10, wherein the at least one lamellae pack assembly (11) is removable and/or replaceable for cleaning or ser-vicing from only a first end (9) of the scroll assembly (1).

12. The scroll assembly (1) for a centrifuge (100) according to any one of the preceding claims, further comprising the bowl (30); wherein the bowl (30) is selected from a screen-bowl or a solidbowl.
